(19) United States
(12) Patent Application Publication
(10) Pub. No.: US 2026/0087635 A1
(43) Pub. Date: Mar. 26, 2026

(54) IMAGE OBJECT MASK GENERATION

(71) Applicant: QUALCOMM Incorporated, San Diego, CA (US)

(72) Inventors: Davide ABATI, Amsterdam (NL); Jens PETERSEN, Amsterdam (NL); Auke Joris WIGGERS, Amsterdam (NL); Amirhossein HABIBIAN, Amsterdam (NL)

(21) Appl. No.: 18/892,031

(22) Filed: Sep. 20, 2024

(51) Int. Cl. G06T 7/12; G06T 5/50; G06V 10/44; G06V 10/80

(52) U.S. Cl. CPC G06T 7/12; G06T 5/50; G06V 10/44; G06V 10/806; G06T 2207/20221

(57) ABSTRACT

A device includes a memory configured to store image data. The device also includes one or more processors coupled to the memory and configured to obtain a first group of feature sets from a first sampling iteration of multiple sampling iterations associated with a diffusion model, where the multiple sampling iterations are configured to generate a latent representation of a first image. The one or more processors are also configured to generate, based on the first group of feature sets, first mask data that indicates a first mask associated with a first object of the first image.

### I. FIELD

The present disclosure is generally related to image object mask generation.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Such computing devices often incorporate functionality to generate image data. For example, generative data augmentation (GDA) (generating synthetic data to extend the training set of a learning model) is re-gaining popularity as generative models advance. Possible applications include data generation for automotive perception, where edge case scenarios are potentially safety-critical and costly to acquire. Typically, cut-and-paste approaches generate a pool of images, which are pasted into real or synthetic backgrounds. The resulting images do not look realistic, as foreground objects blend poorly with the background or appear out of context.

### III. SUMMARY

According to one implementation of the present disclosure, a device includes a memory configured to store image data. The device also includes one or more processors coupled to the memory and configured to obtain a first group of feature sets from a first sampling iteration of multiple sampling iterations associated with a diffusion model. The multiple sampling iterations are configured to generate a latent representation of a first image. The one or more processors are also configured to generate, based on the first group of feature sets, first mask data that indicates a first mask associated with a first object of the first image.

According to another implementation of the present disclosure, a method of operation of a device is disclosed. The method includes obtaining a first group of feature sets from a first sampling iteration of multiple sampling iterations associated with a diffusion model. The multiple sampling iterations are configured to generate a latent representation of a first image. The method also includes generating, based on the first group of feature sets, first mask data that indicates a first mask associated with a first object of the first image.

According to another implementation of the present disclosure, a non-transitory computer-readable medium stores instructions that, when executed by one or more processors, cause the one or more processors to obtain a first group of feature sets from a first sampling iteration of multiple sampling iterations associated with a diffusion model. The multiple sampling iterations are configured to generate a latent representation of a first image. The instructions further cause the one or more processors to generate, based on the first group of feature sets, first mask data that indicates a first mask associated with a first object of the first image.

According to another implementation of the present disclosure, an apparatus includes means for obtaining a first group of feature sets from a first sampling iteration of multiple sampling iterations associated with a diffusion model. The multiple sampling iterations are configured to generate a latent representation of a first image.

The apparatus also includes means for generating, based on the first group of feature sets, first mask data that indicates a first mask associated with a first object of the first image.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a diagram of an illustrative aspect of operations associated with image object mask generation, in accordance with some examples of the present disclosure.

FIG. 2 is a block diagram of a particular illustrative aspect of a system operable to perform image object mask generation, in accordance with some examples of the present disclosure.

FIG. 3 is a diagram of an illustrative aspect of a system operable to train an image generator to perform image object mask generation, in accordance with some examples of the present disclosure.

FIG. 4 is a diagram of an illustrative aspect of a sampling iteration of a diffusion model of a system operable to perform image object mask generation, in accordance with some examples of the present disclosure.

FIG. 5 is a diagram of an illustrative aspect of a mask decoder operable to perform image object mask generation, in accordance with some examples of the present disclosure.

FIG. 6 illustrates an example of an integrated circuit operable to perform image object mask generation, in accordance with some examples of the present disclosure.

FIG. 7 is a diagram of a mobile device operable to perform image object mask generation, in accordance with some examples of the present disclosure.

FIG. 8 is a diagram of a wearable electronic device operable to perform image object mask generation, in accordance with some examples of the present disclosure.

FIG. 9 is a diagram of a mixed reality or augmented reality glasses device operable to perform image object mask generation, in accordance with some examples of the present disclosure.

FIG. 10 is a diagram of a voice-controlled speaker system operable to perform image object mask generation, in accordance with some examples of the present disclosure.

FIG. 11 is a diagram of a camera operable to perform image object mask generation, in accordance with some examples of the present disclosure.

FIG. 12 is a diagram of a headset, such as a virtual reality, mixed reality, or augmented reality headset, operable to perform image object mask generation, in accordance with some examples of the present disclosure.

FIG. 13 is a diagram of a first example of a vehicle operable to perform image object mask generation, in accordance with some examples of the present disclosure.

FIG. 14 is a diagram of a second example of a vehicle operable to perform image object mask generation, in accordance with some examples of the present disclosure.

FIG. 15 is a diagram of a particular implementation of a method of image object mask generation that may be performed by the system of FIG. 2, in accordance with some examples of the present disclosure.

FIG. 16 is a block diagram of a particular illustrative example of a device that is operable to perform image object mask generation, in accordance with some examples of the present disclosure.

### V. DETAILED DESCRIPTION

Augmented image generation typically, in cut-and-paste approaches, includes generating a pool of images, which are pasted into real or synthetic backgrounds. The resulting images do not look realistic, as foreground objects blend poorly with the background or appear out of context.

Systems and methods of image object mask generation are disclosed. For example, an image generator includes a sampling engine and a mask decoder. The sampling engine includes a diffusion model. The sampling engine is configured to perform multiple sampling iterations of the diffusion model that are configured to generate a latent image representation. An image decoder outputs a generated image (e.g., a synthesized image) based on the latent representation. The mask decoder generates, based on features output from a sampling iteration of the multiple sampling iterations, mask data that indicates a mask associated with an object of the generated image. In an illustrative example, the generated image depicts a car on a country road and the mask corresponds to a detected outline of the representation of the car in the generated image.

The generated image and the mask data can be used to augment a background image with the object. For example, an output image generator uses the mask data to apply the mask to the generated image to output a segmented image that includes a representation of the object. In an illustrative example, the segmented image includes the representation of the car and a transparent background so that portions of other elements (such as the country road, trees, or sky) from the generated image are reduced (e.g., absent) in the segmented image. The output image generator combines the background image and the segmented image to generate the output image. For example, the background image depicts a city street and the output image depicts the car on the city street. In a particular aspect, an alpha channel of an image indicates opacity information of pixels of the image. For example, a first pixel value (e.g., an alpha value of 0) indicates that a pixel is fully transparent, whereas a second pixel value (e.g., an alpha value of 255) indicates that the pixel has full opacity. A “transparent” pixel enables a corresponding pixel of a lower layer or background to show through. For example, the “transparent” portion of the segmented image, that is layered on top of the background image to generate the output image, enables the corresponding portion of the background image to be visible in the output image. Artifacts corresponding to portions of other elements (e.g., the country road, trees, or sky) from the generated image are thus reduced in (e.g., not added to) the output image.

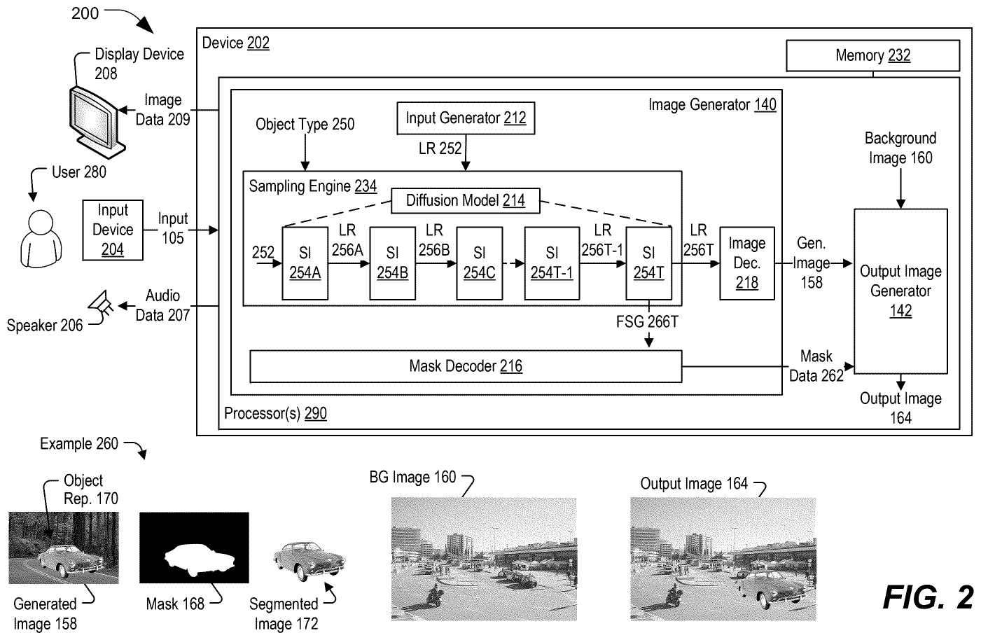

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 2 depicts a device 202 including one or more processors (“processor(s)” 290 of FIG. 2), which indicates that in some implementations the device 202 includes a single processor 290 and in other implementations the device 202 includes multiple processors 290. For ease of reference herein, such features are generally introduced as “one or more” features and are subsequently referred to in the singular or optional plural (as indicated by “(s)”) unless aspects related to multiple of the features are being described.

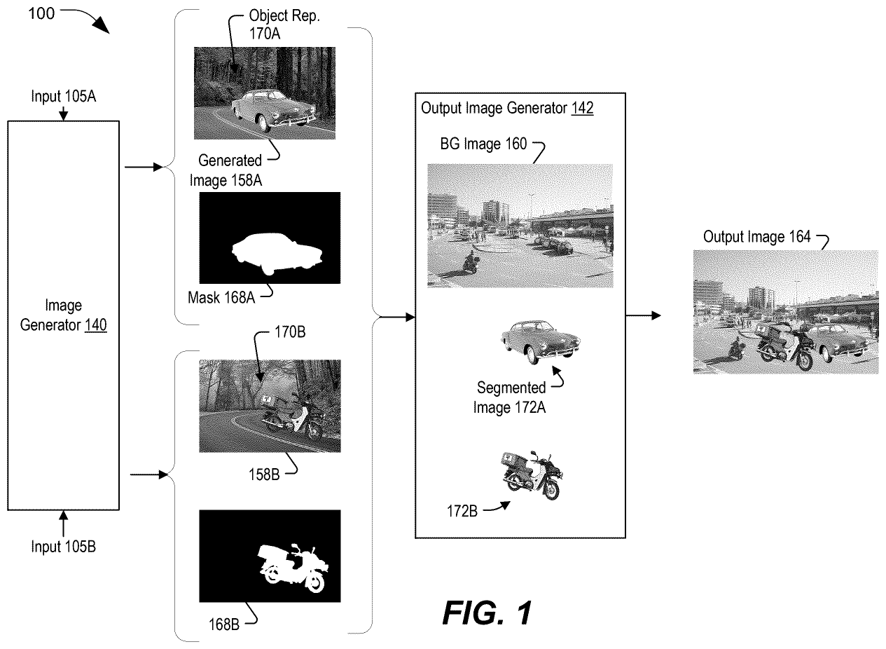

In some drawings, multiple instances of a particular type of feature are used. Although these features are physically and/or logically distinct, the same reference number is used for each, and the different instances are distinguished by addition of a letter to the reference number. When the features as a group or a type are referred to herein e.g., when no particular one of the features is being referenced, the reference number is used without a distinguishing letter. However, when one particular feature of multiple features of the same type is referred to herein, the reference number is used with the distinguishing letter. For example, referring to FIG. 1, multiple generated images are illustrated and associated with reference numbers 158A and 158B. When referring to a particular one of these generated images, such as a generated image 158A, the distinguishing letter “A” is used. However, when referring to any arbitrary one of these generated images or to these generated images as a group, the reference number 158 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows—a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” In transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

Referring to FIG. 1, a diagram 100 is shown of an illustrative aspect of operations associated with image object mask generation, in accordance with some examples of the present disclosure. An image generator 140 is configured to output a generated image 158 and mask data of a mask 168, as further described with reference to FIG. 2.

In an example, during a first iteration of the image generator 140, the image generator 140 outputs a generated image 158A that includes an object representation 170A of an object (e.g., a car). The image generator 140 also outputs mask data of a mask 168A of the object in the generated image 158A. In a particular embodiment, the mask 168A corresponds to an outline of the object representation 170A. Optionally, in some examples, the image generator 140 generates the generated image 158A based on input 105A (e.g., a prompt) indicating an object type (e.g., a vehicle). To illustrate, the image generator 140 outputs the generated image 158A including an object representation 170A of an object (e.g., a car, a motorcycle, an airplane, etc.) of the object type, as further described with reference to FIG. 2.

In another example, during a second iteration of the image generator 140, the image generator 140 outputs a generated image 158B that includes an object representation 170B of an object (e.g., a motorcycle). The image generator 140 also outputs mask data of a mask 168B of the object in the generated image 158B. In a particular embodiment, the mask 168B corresponds to an outline of the object representation 170B. Optionally, in some examples, the image generator 140 generates the generated image 158B based on an input 105B. In some examples, the input 105B is the same as the input 105A (e.g., a “vehicle”). In other examples, the input 105B (e.g., a “one-person vehicle”) is distinct from the input 105A (e.g., a “four-passenger vehicle”).

In a particular aspect, a mask 168 corresponds to an alpha mask. For example, each pixel value of a mask 168 indicates an opacity value. To illustrate, each pixel of the mask 168A corresponding to a portion of the object representation 170A has a first value (e.g., an alpha value of 0) indicating that the pixel is fully transparent and each pixel of the mask 168A corresponding to a remaining portion of the generated image 158A has a second value (e.g., an alpha value of 255) indicating that the pixel has full opacity. In some embodiments, the mask 168 corresponds to an alpha channel associated with the generated image 158A. The mask 168 can be applied to (e.g., layered on) the generated image 158A to generate a masked image in which pixels of the portion of the object representation 170A in the generated image 158A show through in the masked image and remaining pixels of the generated image 158A are not visible in the masked image.

A generated image 158 and a corresponding mask 168 (e.g., mask data) can be used for various purposes. As an example, an output image generator 142 is configured to generate an output image 164 based on a background (BG) image 160, a generated image 158, and a mask 168 (e.g., mask data), as further described with reference to FIG. 2. To illustrate, in some embodiments, the output image generator 142 applies the mask 168A (e.g., the mask data) to the generated image 158A to generate a segmented image 172A (e.g., a masked image). In a particular aspect, the segmented image 172A includes at least a portion of the object representation 170A (e.g., of the car), whereas remaining portions of the generated image 158A are reduced (e.g., absent) in the segmented image 172A. For example, the output image generator 142 determines that a first pixel of the segmented image 172A corresponds to a first pixel of the mask 168 and a first pixel of the generated image 158A. The output image generator 142, in response to determining that the first pixel of the mask 168 has the first value (e.g., an alpha value of 0) indicating transparency, determines a pixel value of the first pixel of the segmented image 172A based on a pixel value of the first pixel of the generated image 158A.

Alternatively, the output image generator 142, in response to determining that the first pixel of the mask 168 has the second value (e.g., an alpha value of 255) indicating full opacity, sets the pixel value of the first pixel of the segmented image 172A to a predetermined value. In a particular aspect, the predetermined value (e.g., an alpha value of 0) indicates a transparent pixel. In some embodiments, the segmented image 172A includes a transparent background and at least a portion of the object representation 170A.

As another example, the output image generator 142 applies the mask 168B (e.g., the mask data) to the generated image 158B to generate a segmented image 172B. In a particular aspect, the segmented image 172B includes the object representation 170B (e.g., of the motorcycle), whereas remaining portions of the generated image 158B are reduced (e.g., absent) in the segmented image 172B. To illustrate, in some embodiments, the segmented image 172B includes a transparent background and the object representation 170B.

The output image generator 142 combines the background image 160 and at least one segmented image 172 to generate the output image 164. For example, the output image generator 142 adds (e.g., inpaints) the segmented image 172A at a first location of the background image 160 to generate the output image 164. For example, the output image generator 142 determines that a first pixel of the output image 164 corresponds to a first pixel of the segmented image 172A and a first pixel of the background image 160. The output image generator 142, in response to determining that the first pixel of the segmented image 172A has the first value (e.g., an alpha value of 0) indicating transparency, determines a pixel value of the first pixel of the output image 164 based on a pixel value of the first pixel of the background image 160. Alternatively, the output image generator 142, in response to determining that the first pixel of the segmented image 172A has the second value (e.g., an alpha value of 255) indicating full opacity, determines the pixel value of the first pixel of the output image 164 based on a pixel value of the first pixel of the segmented image 172A. The output image 164 thus includes at least the portion of the object representation 170A (e.g., of the car) and at least a portion of the background image 160. A new object represented by the segmented image 172A can thus be added to a new location in the background image 160 instead of, or in addition to, replacing another object of the same object type in the background image 160. In some examples, the output image generator 142 obtains the background image 160 from a memory, a storage device, a network device, or a combination thereof. In some examples, the output image generator 142 generates the background image 160. In some examples, the image generator 140 generates the background image 160.

In some examples, the output image generator 142 combines the background image 160 with multiple segmented images 172 to generate the output image 164. For example, the output image generator 142 adds the segmented image 172A at the first location and adds the segmented image 172B at a second location of the background image 160 to generate the output image 164. In some aspects, the output image generator 142 adds the segmented images 172 sequentially in a layering order to generate the output image 164. In other aspects, the output image generator 142 adds the segmented images 172 concurrently to the background image 160 to generate the output image 164. For example, the output image generator 142 may add the segmented images 172 concurrently to the background image 160 when the segmented images 172 are going to be non-overlapping in the output image 164 or when the layering order is not predetermined.

A technical advantage of using the mask 168 includes reduced artifacts in the output image 164. For example, the mask 168 reduces portions of the generated image 158, other than at least a portion of the object representation 170, that are included in the segmented image 172. The segmented image 172 can thus be used to generate the output image 164 including at least the portion of the object representation 170 (e.g., a vehicle) with fewer additional artifacts (e.g., portion of a road or trees) from the generated image 158. To illustrate, the output image 164 can be generated based on a dynamically cropped version of the generated image 158 instead of the entire generated image 158.

Referring to FIG. 2, a particular illustrative aspect of a system configured to perform image object mask generation is disclosed and generally designated 200, in accordance with some examples of the present disclosure. The system 200 includes a device 202. The device 202 includes one or more processors 290 coupled to a memory 232. The memory 232 is configured to store data used or generated by the one or more processors 290. For example, the memory 232 is configured to store image data, one or more machine learning models, or a combination thereof.

Optionally, in some embodiments, the one or more processors 290 are configured to be coupled to an input device 204, a speaker 206, a display device 208, one or more additional devices, or a combination thereof. In an example, the one or more processors 290 are coupled to the input device 204 and the input device 204 is configured to provide an input 105 to the one or more processors 290. In some examples, the input device 204 includes at least one of a keyboard, a microphone, a camera, a touch screen, a phone, a tablet, or a sensor. To illustrate, the input 105 can include audio data representing speech of a user 280, a keyboard input entered by the user 280, image data representing a gesture performed by the user 280, etc.

In some examples, the one or more processors 290 are coupled to the speaker 206 and are configured to provide audio data 207 to the speaker 206. The speaker 206 is configured to output audio corresponding to the audio data 207. In some examples, the one or more processors 290 are coupled to the display device 208 and are configured to provide image data 209 to the display device 208. The display device 208 is configured to display an image corresponding to the image data 209.

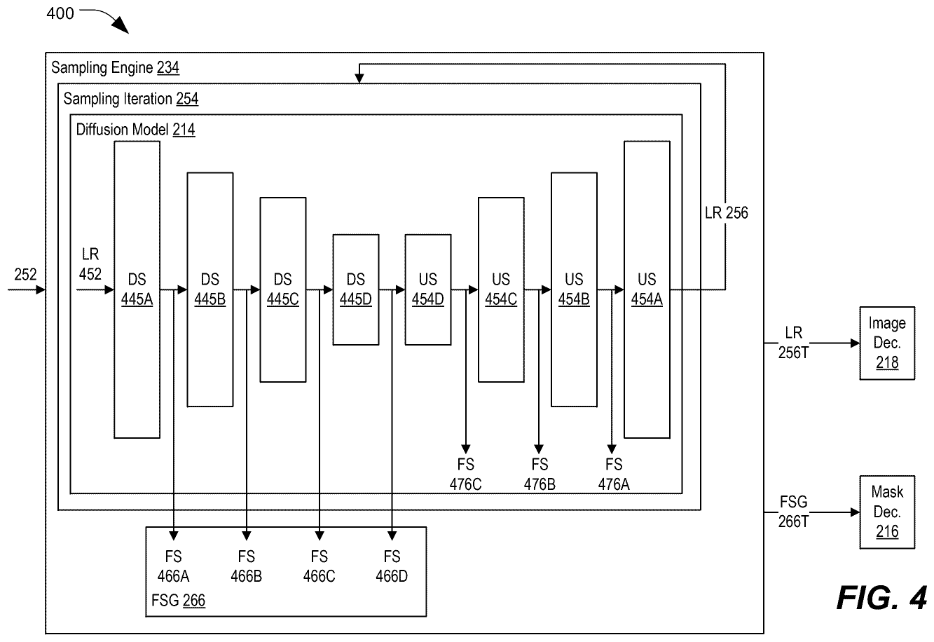

The image generator 140 is configured to output a generated image 158 and mask data 262 that indicates a mask associated with an object of the generated image 158. The image generator 140 includes an input generator 212 coupled via a sampling engine 234 to an image decoder 218. The sampling engine 234 includes a diffusion model 214. In some implementations, the diffusion model 214 has a U-Net architecture. For example, the diffusion model 214 includes an encode portion (e.g., including one or more downsampling stages) and a decode portion (e.g., one or more upsampling stages), as further described with reference to FIG. 4. The encode portion downsamples to generate feature sets having different resolutions and the decode portion upsamples to generate feature sets having different resolutions. The image generator 140 also includes a mask decoder 216 coupled to the sampling engine 234.

The one or more processors 290 include at least the mask decoder 216 of the image generator 140. Optionally, in some embodiments, the one or more processors 290 include one or more additional components of the image generator 140, such as the input generator 212, the sampling engine 234, the diffusion model 214, the image decoder 218, or a combination thereof. Optionally, in some embodiments, the image generator 140 is configured to be coupled to the output image generator 142. In some embodiments, the one or more processors 290 include the output image generator 142. In some other embodiments, the output image generator 142 is integrated in a second device that is external to the device 202. In some implementations, the image generator 140 corresponds to an autoencoder that includes an encoder (e.g., including the input generator 212), a denoiser (e.g., including the sampling engine 234), a decoder (e.g., including the image decoder 218, the mask decoder 216, or both), or a combination thereof.

The input generator 212 is configured to generate a latent representation 252 of noise data usable by the sampling engine 234 to output a latent representation 256T that can be decoded by the image decoder 218 to output the generated image 158 that includes an object representation 170 of an object (e.g., a car, a truck, a motorcycle, an airplane, etc.) of an object type 250. In a particular embodiment, the input generator 212 is configured to sample noise data from a noise distribution (e.g., a Gaussian distribution) and to encode the sampled noise data to generate the latent representation 252. Optionally, in some embodiments, the input generator 212 is configured to sample the noise data, encode the sampled noise data, or both, based on the object type 250.

The image generator 140 is configured to use the sampling engine 234 to process the latent representation 252 of noise data to generate a latent representation 256T that can be decoded by the image decoder 218 to output the generated image 158. The sampling engine 234 performs multiple sampling iterations 254 of the diffusion model 214 that are configured to generate the latent representation 256T of the generated image 158, as further described with reference to FIG. 4.

In an example, the sampling iterations 254 include a sampling iteration 254A, a sampling iteration 254B, a sampling iteration 254C, one or more additional sampling iterations, a sampling iteration 254T-1, a sampling iteration 254T, or a combination thereof. It should be understood that the sampling engine 234 performing at least 5 sampling iterations of the diffusion model 214 is provided as an illustrative example, in some other examples the sampling engine 234 can perform fewer than 5 sampling iterations of the diffusion model 214. In some implementations, the sampling engine 234 is included in a denoiser and each sampling iteration 254 corresponds to a denoising step of the denoiser. For example, during an initial sampling iteration (e.g., the sampling iteration 254A), the diffusion model 214 processes the latent representation 252 of noise data to generate a latent representation 256A of less noisy image data. Each subsequent sampling iteration 254 of the diffusion model 214 generates a latent representation 256 of cleaner image data as compared to the previous sampling iteration. Optionally, in some embodiments, the sampling engine 234 processes the latent representation 252 based on the object type 250 to generate the latent representation 256T. The image decoder 218 is configured to process the latent representation 256T to output the generated image 158.

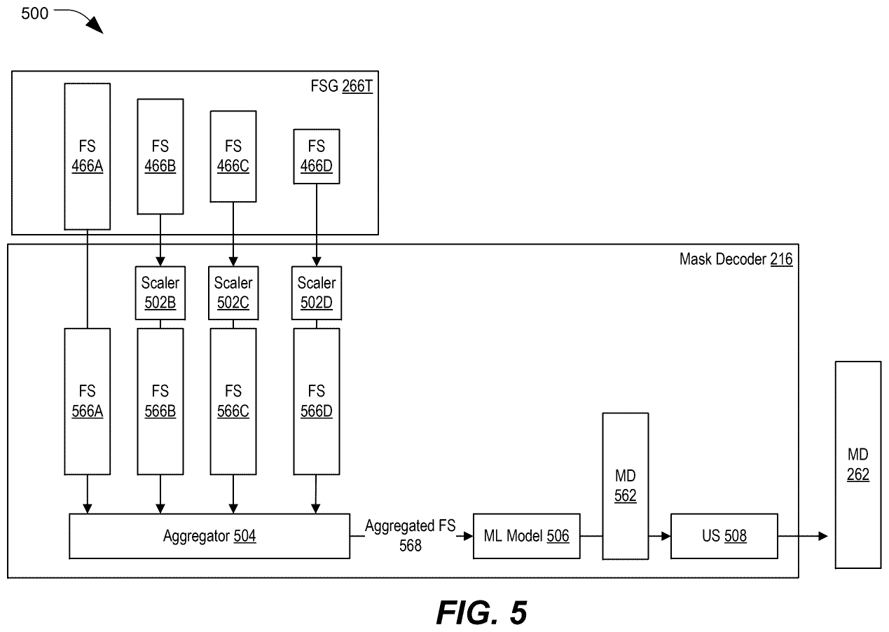

The mask decoder 216 is configured to generate mask data 262 based on at least one feature set group (FSG) 266 from at least one sampling iteration 254 of the diffusion model 214, as further described with reference to FIG. 5. For example, the diffusion model 214 includes multiple sampling stages (e.g., one or more downsampling stages and one or more upsampling stages), and a feature set group 266 from a sampling iteration 254 includes feature sets output by one or more of the sampling stages of the diffusion model 214 during the sampling iteration 254. To illustrate, a first feature set output by a first sampling stage of the diffusion model 214 has a first resolution and a second feature set output by a second sampling stage of the diffusion model 214 has a second resolution. In some implementations, the first resolution is the same as the second resolution. In other implementations, the second resolution is lower than the first resolution.

In a particular example, the mask decoder 216 is configured to generate the mask data 262 based on a FSG 266T from a final sampling iteration (e.g., the sampling iteration 254T) of the diffusion model 214. In another example, the mask decoder 216 is configured to generate the mask data 262 based on an FSG 266 from another sampling iteration that is prior to the final sampling iteration of the diffusion model 214. In a particular embodiment, the mask decoder 216 is configured to generate the mask data 262 based on FSGs 266 from multiple sampling iterations of the diffusion model 214. The mask data 262 represents a mask 168 associated with an object of the generated image 158.

Optionally, in some embodiments, the image generator 140 is configured to provide the generated image 158 and the mask data 262 to the output image generator 142. The output image generator 142 is configured to generate an output image 164 based on the generated image 158, the mask data 262, and a background image 160. For example, the output image generator 142 is configured to use the mask data 262 to apply the mask 168 to the generated image 158 to generate a segmented image 172 of the object and to add the segmented image 172 to the background image 160 to generate the output image 164.

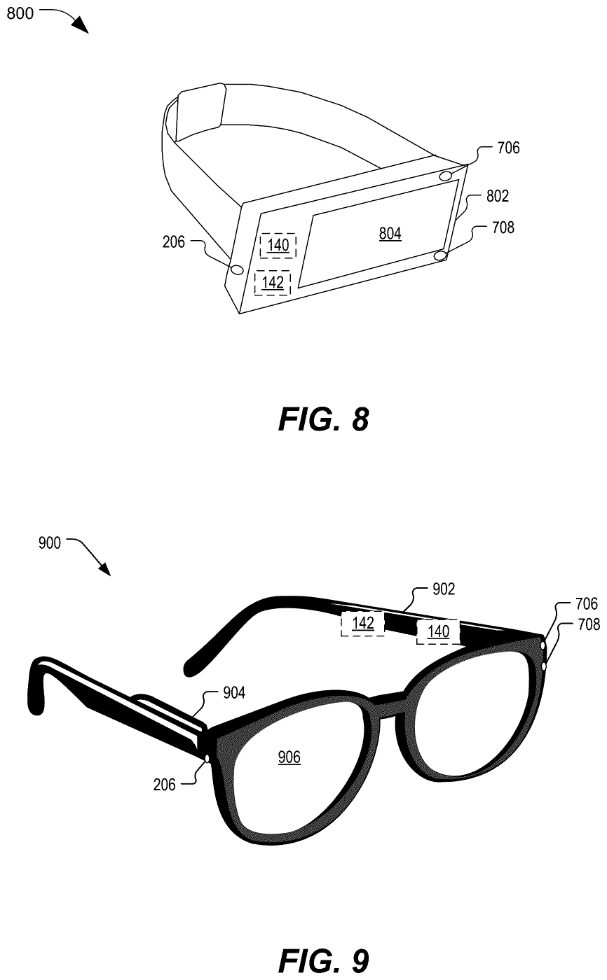

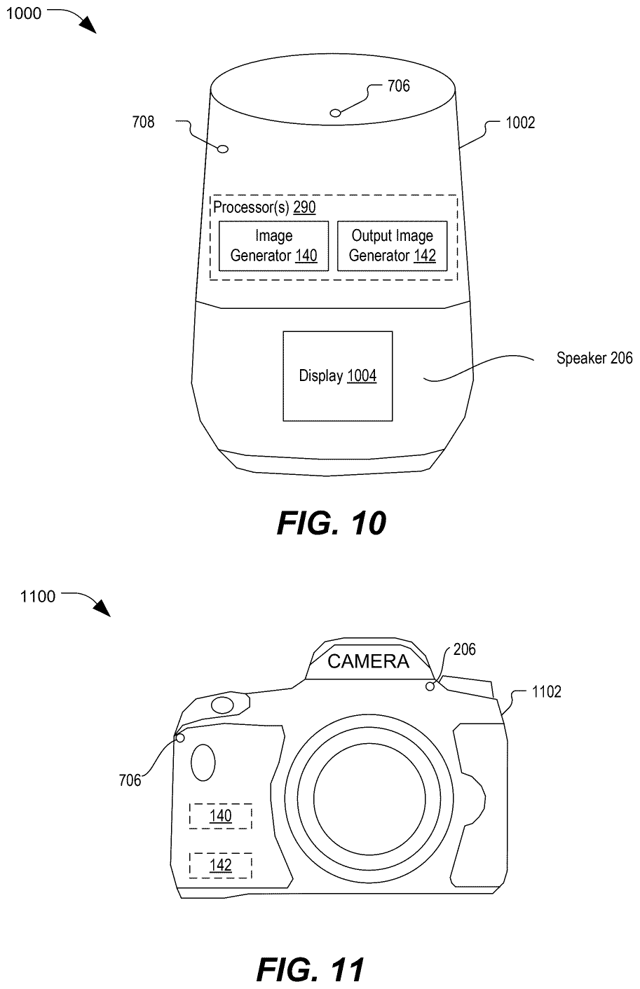

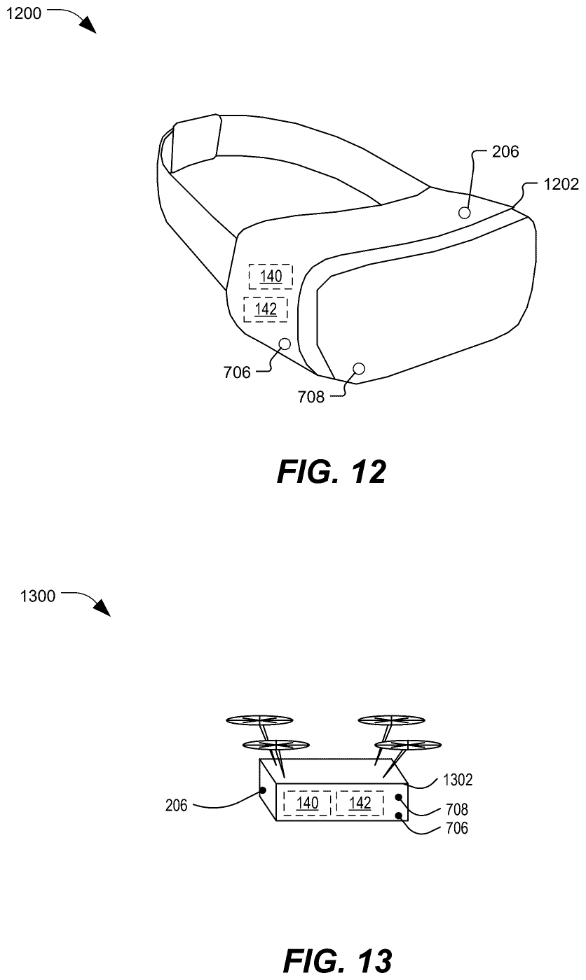

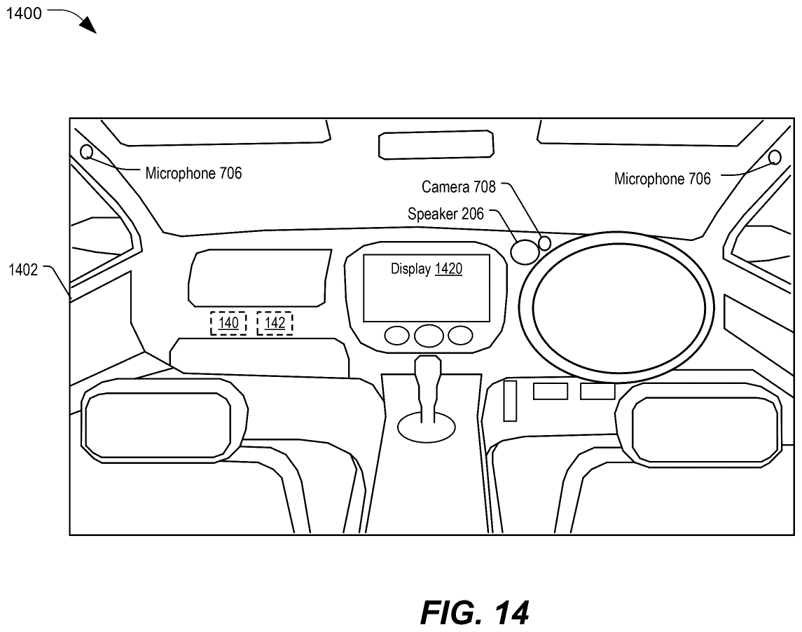

In some implementations, the device 202 corresponds to or is included in one of various types of devices. In an illustrative example, the one or more processors 290 are integrated in at least one of a mobile phone or a tablet computer device, as described with reference to FIG. 7, a wearable electronic device, as described with reference to FIG. 8, a mixed reality or augmented reality glasses device, as described with reference to FIG. 9, a voice-controlled speaker system, as described with reference to FIG. 10, a camera device, as described with reference to FIG. 11, or a virtual reality, mixed reality, or augmented reality headset, as described with reference to FIG. 12. In another illustrative example, the one or more processors 290 are integrated into a vehicle, such as described further with reference to FIG. 13 and FIG. 14.

During operation, in some examples, a user 280 provides an input 105 via the input device 204 to cause the image generator 140 to output a generated image 158. Optionally, in some embodiments, the input 105 indicates an object type 250 (e.g., a “vehicle”) that is to be depicted in the generated image 158. In some embodiments, the object type 250 is based on a configuration setting, default data, or both.

The input generator 212 of the image generator 140 generates a latent representation 252. For example, the input generator 212 samples noise data from a noise distribution (e.g., a Gaussian distribution) and generates the latent representation 252 of the noise data. To illustrate, in some embodiments, the input generator 212 applies techniques such as dimensionality reduction, feature extraction, generative models, etc. to the noise data to generate the latent representation 252. Optionally, in some embodiments, the input generator 212 generates the latent representation 252 based on the object type 250. For example, the input generator 212 generates the noise distribution, samples the noise data, or both, based on the object type 250.

The sampling engine 234 processes the latent representation 252 (e.g., an input latent representation) to generate a latent representation 256T that can be decoded by the image decoder 218 to generate the generated image 158. In an example, the sampling engine 234 performs one or more iterations of the diffusion model 214 to generate the latent representation 256T. An initial sampling iteration (e.g., the sampling iteration 254A) of the diffusion model 214 processes the latent representation 252 of noise data to output an initial latent representation (e.g., a latent representation 256A), each subsequent sampling iteration of the diffusion model 214 processes an output of a prior sampling iteration of the diffusion model 214, and a final sampling iteration (e.g., the sampling iteration 254T) of the diffusion model 214 outputs the latent representation 256T of the generated image 158, as further described with reference to FIG. 4. To illustrate, the sampling iteration 254A processes the latent representation 252 to generate the latent representation 256A, the sampling iteration 254B processes the latent representation 256A to generate a latent representation 256B, the sampling iteration 254C processes the latent representation 256B, and so on. The sampling iteration 254T processes a latent representation 256T-1 from the sampling iteration 254T-1 to generate the latent representation 256T. In some examples, the sampling engine 234 is included in a denoiser and each subsequent latent representation 256 represents less noisy image data. In some aspects, a “sampling iteration” may also be referred to as a “sampling step” or a “diffusion sampling step.”

Optionally, in some embodiments, the diffusion model 214 processes the latent representation 252 based on the object type 250 to generate the latent representation 256T. For example, the object type 250 can be input to one or more of the sampling iterations 254 of the diffusion model 214.

The image decoder 218 decodes the latent representation 256T to output the generated image 158. In an example 260, the generated image 158 includes an object representation 170 of an object (e.g., a car) of the object type 250 (e.g., a “vehicle”). The generated image 158 can also depict additional elements, such as a background including trees and a road.

Each sampling iteration of the diffusion model 214 generates a corresponding feature set group 266, as further described with reference to FIG. 4. For example, the sampling iteration 254T generates a feature set group (FSG) 266T. The mask decoder 216 processes one or more FSGs 266 to generate the mask data 262, as further described with reference to FIG. 5. In a particular embodiment, the mask decoder 216 obtains the FSG 266T from the sampling iteration 254T and generates, based on the FSG 266T, the mask data 262 that indicates a mask 168 associated with the object (e.g., the car) of the generated image 158. For example, the mask 168 corresponds to an area (e.g., an outline) that is detected as associated with the object representation 170 of the object (e.g., the car). The image generator 140 outputs the generated image 158 and the mask data 262.

It should be understood that the mask decoder 216 generating the mask data 262 based on the FSG 266T from the final sampling iteration of the diffusion model 214 is provided as an illustrative example. In other examples, the mask decoder 216 can generate the mask data 262 based on one or more FSGs 266 from corresponding one or more sampling iterations 254 of the diffusion model 214. In an example, the mask decoder 216 obtains the FSG 266T from the sampling iteration 254T, obtains a second FSG 266 from the sampling iteration 254T-1, and generates the mask data 262 based on the FSG 266T and the second FSG 266.

The generated image 158 and the mask data 262 can be used for various purposes. In an example, the output image generator 142 obtains a background image 160 and generates an output image 164 that includes the object representation 170 and at least a portion of the background image 160. Optionally, in some embodiments, the input device 204 includes a camera coupled to the one or more processors 290 and the camera is configured to generate the background image 160.

In the example 260, the output image generator 142 uses the mask data 262 to apply the mask 168 to the generated image 158 to generate a segmented image 172 of the object (e.g., the car). To illustrate, the segmented image 172 includes at least a portion of the object representation 170 (e.g., the car), and remaining portions of the generated image 158 are reduced (e.g., absent) in the segmented image 172. The output image generator 142 adds the segmented image 172 (e.g., of the car) to the background image 160 (e.g., of a city road) to generate the output image 164. The output image 164 thus includes at least the portion of the object representation 170 and at least a portion of the background image 160.

Optionally, in some embodiments, the one or more processors 290 provide image data 209 to the display device 208. For example, the image generator 140 generates image data 209 based on the generated image 158, the mask data 262, or both, and provides the image data 209 to the display device 208. The display device 208 displays the generated image 158, the mask 168, or both. In another example, the output image generator 142 generates image data 209 based on the generated image 158, the mask data 262, the segmented image 172, the background image 160, the output image 164, or a combination thereof, and provides the image data 209 to the display device 208. The display device 208 displays the generated image 158, the mask 168, the segmented image 172, the background image 160, the output image 164, or a combination thereof. To illustrate, the output image generator 142 generates the output image 164 (e.g., output image data) that is provided, as the image data 209, to the display device 208 for display by the display device 208.

Optionally, in some embodiments, the one or more processors 290 provide audio data 207 to the speaker 206. In some aspects, the speaker 206 is configured to output audio based on the audio data 207 concurrently with the display device 208 displaying one or more images based on the image data 209. In an illustrative example, the output image generator 142 obtains background audio data associated with the background image 160. Additionally, or in the alternative, the output image generator 142, based on determining that the segmented image 172 includes the object representation 170, obtains additional audio data corresponding to at least the object (e.g., the car) or the object type 250 (e.g., a vehicle). The output image generator 142, responsive to adding the segmented image 172 to the background image 160, generates the audio data 207 based on the background audio data, the additional audio data, or both, and provides the audio data 207 to the speaker 206. In a particular aspect, the speaker 206 is configured to, concurrently with one or more images (e.g., the generated image 158, the mask 168, the segmented image 172, the background image 160, the output image 164, or a combination thereof) being displayed at the display device 208, output audio (e.g., based at least on the additional audio data) associated with the object (e.g., the car).

In some aspects, multiple iterations of the image generator 140 can be used to independently generate multiple generated images 158 and corresponding mask data 262. For example, as shown in FIG. 1, a first iteration of the image generator 140 outputs the generated image 158A (e.g., including the object representation 170A of the car) and first mask data 262 representing the mask 168A and a second iteration of the image generator 140 outputs the generated image 158B (e.g., including the object representation 170B of the motorcycle) and second mask data 262 representing the mask 168B. In some aspects, each of the first iteration and the second iteration is based on the same input 105 (e.g., a “vehicle”). In other aspects, the first iteration is based on a first input 105 (e.g., a “4 passenger vehicle”) and the second iteration is based on a second input 105 (e.g., a “1 person vehicle”).

During the first iteration, the input generator 212 generates a first latent representation 252. For example, the input generator 212 samples first noise data from a first noise distribution (e.g., Gaussian distribution) and generates the first latent representation 252 of the first noise data. The sampling engine 234 processes the first latent representation 252 to generate a first latent representation 256T. The mask decoder 216 obtains one or more first FSG 266 (e.g., a first FSG 266T) from one or more first sampling iterations 254 of the diffusion model 214. The mask decoder 216 generates, based on the one or more first FSG 266, first mask data 262 that indicates a mask 168A associated with a first object (e.g., the car) of the generated image 158A.

The one or more first sampling iterations 254 are configured to generate the first latent representation 256T of the generated image 158B. The image decoder 218 processes the first latent representation 256T to generate the generated image 158A.

During the second iteration, the input generator 212 generates a second latent representation 252. For example, the input generator 212 samples second noise data from a second noise distribution (e.g., Gaussian distribution) and generates the second latent representation 252 of the second noise data. The sampling engine 234 processes the second latent representation 252 to generate a second latent representation 256T. The mask decoder 216 obtains one or more second FSG 266 (e.g., a second FSG 266T) from one or more second sampling iterations 254 of the diffusion model 214. The mask decoder 216 generates, based on the one or more second FSG 266, second mask data 262 that indicates the mask 168B associated with a second object (e.g., the motorcycle) of the generated image 158B. The one or more second sampling iterations 254 are configured to generate the second latent representation 256T of the generated image 158B. The image decoder 218 processes the second latent representation 256T to generate the generated image 158B.

Optionally, in some embodiments, the output image generator 142 generates the output image 164 including the object representation 170A of the first object (e.g., car), the object representation 170B of the second object (e.g., motorcycle), and at least a portion of the background image 160, as described with reference to FIG. 1. The object representation 170A (that is included in the output image 164) is based on the generated image 158A and the first mask data 262. The object representation 170B (that is included in the output image 164) is based on the generated image 158B and the second mask data 262.

It should be understood that two iterations of the image generator 140 are described as an illustrative example, in other examples any count of iterations of the image generator 140 can be performed and the output image generator 142 can generate the output image 164 based on any count of generated images 158 and corresponding mask data 262.

A technical advantage of the system 200 includes enabling the output image generator 142 to generate the output image 164 with reduced artifacts. For example, the output image 164 includes at least the portion of the object representation 170 (e.g., of the car) with reduced (e.g., no) additional artifacts from remaining portions (e.g., road or trees) of the generated image 158. The output image generator 142 can be used to perform generative data augmentation. For example, the output image generator 142 can be used to generate multiple output images 164 to produce an augmented image data set. The augmented image data set includes a realistic and more diverse set of images (as compared to an image data set including the background images 160 and the segmented images 172) that can prove useful in training one or more downstream models.

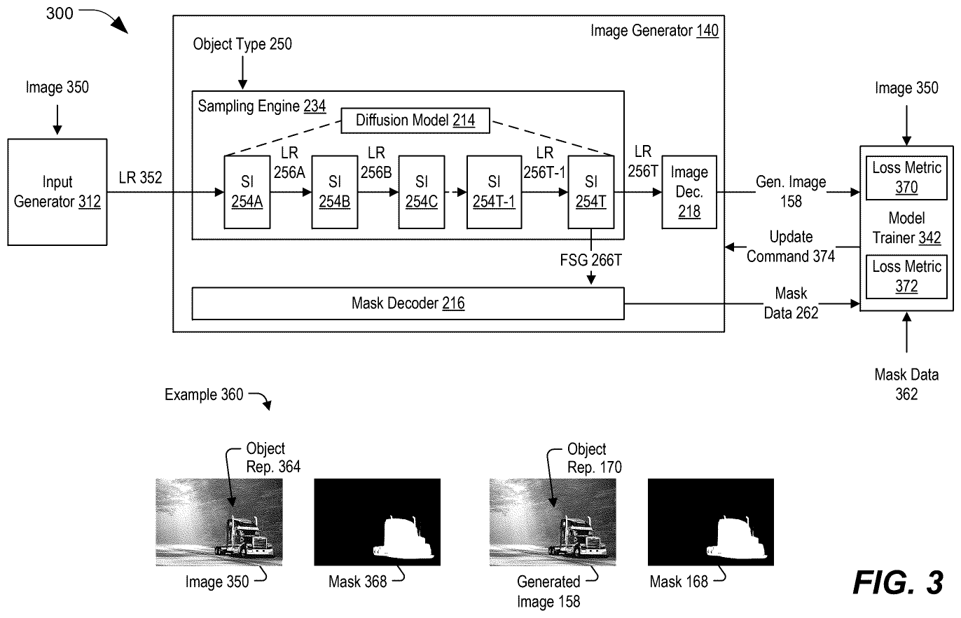

Referring to FIG. 3, a particular illustrative aspect of a system operable to train one or more components of the image generator 140 is disclosed and generally designated 300, in accordance with some examples of the present disclosure. The system 300 includes the image generator 140 coupled to an input generator 312 and a model trainer 342.

Optionally, in some embodiments, one or more components of the system 300 are included in the system 200. In some examples, the one or more processors 290 of the device 202 include the input generator 312, the model trainer 342, or both. In some other examples, a second device includes the input generator 312, the model trainer 342, or both, and provides the image generator 140 to the device 202. To illustrate, the second device provides data (e.g., parameters, configuration settings, or both) representing the image generator 140 to the device 202.

The model trainer 342 obtains training data that includes an image 350 and mask data 362. The image 350 includes an object representation 364 of an object (e.g., a truck) of an object type 250 (e.g., a vehicle). The mask data 362 represents a mask 368 of the object of the image 350. For example, the mask 368 corresponds to an outline of the object representation 364 in the image 350.

The input generator 312 processes the image 350 to generate a latent representation 352. Optionally, in some embodiments, the input generator 312 encodes the image 350 to generate an encoded image (e.g., a latent representation of the image 350) and adds noise data to the encoded image to generate the latent representation 352, Optionally, in other embodiments, the input generator 312 adds noise (e.g., sampled Gaussian noise) to the image 350 to generate a noise-added image and outputs the latent representation 352 of the noise-added image.

During a training iteration, the image generator 140 processes the latent representation 352 (e.g., an input latent representation) obtained from the input generator 312 (instead of the input generator 212) to output a generated image 158 and mask data 262, as described with reference to FIG. 2. For example, the image generator 140 uses the sampling engine 234 to process the latent representation 352 to generate the latent representation 256T of the generated image 158 and uses the image decoder 218 to process the latent representation 256T to output the generated image 158. The generated image 158 includes an object representation 170 of an object. The image generator 140 uses the mask decoder 216 to process one or more FSGs 266 (e.g., the FSG 266T) from one or more sampling iterations 254 (e.g., the sampling iteration 254T) of the diffusion model 214 to generate the mask data 262 representing a mask 168 of the object of the generated image 158.

The model trainer 342 obtains a loss metric 370 based on a comparison of the generated image 158 and the image 350, a loss metric 372 based on a comparison of the mask data 262 and the mask 368, or both. The model trainer 342 trains the diffusion model 214, the mask decoder 216, or both, to reduce a loss metric (e.g., the loss metric 370, the loss metric 372, or both). In a particular aspect, the loss metric corresponds to an L1 loss, e.g., mean absolute error (MAE).

The model trainer 342 updates the image generator 140 (e.g., the diffusion model 214, the mask decoder 216, or both) based on the loss metric 370, the loss metric 372, or both. For example, the model trainer 342, based on the loss metric 370, the loss metric 372, or both, sends an update command 374 to update one or more parameters (e.g., model parameters) of the image generator 140 (e.g., the diffusion model 214, the mask decoder 216, or both).

In some aspects, the model trainer 342 performs one or more additional training iterations until a training stop condition is satisfied. For example, the model trainer 342 performs additional training iterations until at least a threshold count of iterations have been performed, the loss metric 370 reaches a target metric value, the loss metric 372 reaches a target metric value, or a combination thereof. In an example 360, at an end of training, a first similarity between the generated image 158 and the image 350 is greater than a first similarity threshold, and a second similarity between the mask 168 and the mask 368 is greater than a second similarity threshold.

Optionally, in some embodiments, the model trainer 342 updates one or more parameters of the diffusion model 214 and updates one or more parameters of the mask decoder 216 based on the loss metric 370, the loss metric 372, or both. Optionally, in some embodiments, the model trainer 342 updates one or more parameters of the diffusion model 214 based on the loss metric 370, and does not update the mask decoder 216 based on the loss metric 370. For example, the mask decoder 216 is either not updated or is updated based on the loss metric 372. Optionally, in some embodiments, the model trainer 342 updates one or more parameters of the mask decoder 216 based on the loss metric 372 and does not update the diffusion model 214. For example, the diffusion model 214 is either not updated or is updated based on the loss metric 370. A technical advantage of an example in which the diffusion model 214 is not updated includes the ability to use the mask decoder 216 with a pre-trained (e.g., off-the-shelf) diffusion model 214 to generate the mask data 262 (e.g., without additional training of the diffusion model 214).

A technical advantage of the model trainer 342 training the image generator 140 (e.g., the mask decoder 216, the diffusion model 214, or both) includes enabling the image generator 140 to adapt to pixel-level statistics to enable the output image 164 to be generated that looks natural in terms of saturation and contrast. The training also enables the image generator 140 (e.g., the mask decoder 216, the diffusion model 214, or both) to resolve ambiguities in category labels used as the object type 250.

Referring to FIG. 4, a diagram 400 is shown of an illustrative aspect of a sampling iteration 254 of the diffusion model 214 included in the sampling engine 234 of the system 200 of FIG. 2, in accordance with some examples of the present disclosure. The diffusion model 214 includes multiple downsampling (DS) stages 445 and a corresponding multiple of upsampling (US) stages 454. In a particular aspect, one operational iteration of the DS stages 445 and the US stages 454 corresponds to a sampling iteration 254 of the diffusion model 214. Optionally, in some embodiments, the diffusion model 214 includes a convolutional neural network (CNN). For example, a DS stage 445, an US stage 454, or both, include one or more CNN layers. In some aspects, the diffusion model 214 corresponds to a U-Net architecture and includes an encode portion (e.g., the DS stages 445) and a decode portion (e.g., the US stages 454).

In an example, the diffusion model 214 includes a DS stage 445A, a DS stage 445B, a DS stage 445C, and a DS stage 445D. The diffusion model 214 also includes an US stage 454A, an US stage 454B, an US stage 454C, and an US stage 454D corresponding to the DS stage 445A, the DS stage 445B, the DS stage 445C, and the DS stage 445D, respectively. The diffusion model 214 including four DS stages 445 and four US stages 454 is provided as an illustrative example. In some examples, the diffusion model 214 can include fewer than four or more than four DS stages 445. In some examples, the diffusion model 214 can include fewer than four or more than four US stages 454. It should be understood that, in some embodiments, the diffusion model 214 can include additional elements that are not shown for ease of illustration. For example, the diffusion model 214 can include one or more skip connections between corresponding sampling stages, such as a first skip connection between the DS stage 445A and the US stage 454A, a second skip connection between the DS stage 445B and the US stage 454B, and so on. A skip connections enables context information to be passed from an earlier sampling stage to a later sampling stage of the diffusion model 214.

The DS stages 445 perform staged downsampling of a LR 452 (e.g., an input LR) to generate a feature set (FS) 466 at each stage. The FS 466 generated by each subsequent DS stage 445 has a lower resolution. For example, the DS stage 445A downsamples the LR 452 having a first resolution (e.g., 64 bits by 64 bits) to generate a FS 466A having a second resolution (e.g., 32 bits by 32 bits). Each subsequent DS stage 445 downsamples an FS 466 obtained from a prior DS stage 445 to generate a next FS 466. For example, the DS stage 445B downsamples the FS 466A to generate a FS 466B having a third resolution (e.g., 16 bits by 16 bits), the DS stage 445C downsamples the FS 466B to generate a FS 466C having a fourth resolution (e.g., 8 bits by 8 bits), the DS stage 445D downsamples the FS 466C to generate a FS 466D having a fifth resolution (e.g., 4 bits by 4 bits), and so on.

The US stages 454 perform staged upsampling of the FS 466 (e.g., the FS 466D) generated by the DS stages 445 (e.g., the DS stage 445D) to generate a FS 476 at each stage. The FS 476 generated by each subsequent US stage 454 has a higher resolution. For example, the US stage 454D upsamples the FS 466D having the fifth resolution (e.g., 4 bits by 4 bits) to generate a FS 476C having the fourth resolution (e.g., 8 bits by 8 bits). Each subsequent US stage 454 upsamples a FS 476 obtained from a prior US stage 454 to generate a next FS 476. For example, the US stage 454C upsamples the FS 476C to generate a FS 476B having the third resolution (e.g., 16 bits by 16 bits), the US stage 454A upsamples the FS 476B to generate a FS 476A having the second resolution (e.g., 32 bits by 32 bits), and the US stage 454A upsamples the FS 476A to generate a LR 256 having the first resolution (e.g., 64 bits by 64 bits).

The latent representation 252 is used as the LR 452 of the sampling iteration 254A of FIG. 2. Each subsequent sampling iteration 254 uses the LR 256 generated by the prior sampling iteration 254 as the LR 452. The LR 256 of the sampling iteration 254T of FIG. 2 is output as the latent representation 256T.

An FSG 266 of a sampling iteration 254 includes the FS 466 of one or more of the DS stages 445 of the sampling iteration 254. For example, the FSG 266 includes the FS 466A, the FS 466B, the FS 466C, the FS 466D, FS of one or more additional DS stages 445, or a combination thereof. To illustrate, the FSG 266T of the sampling iteration 254T includes the FS 466A, the FS 466B, the FS 466C, the FS 466D, FS of one or more additional DS stages 445, or a combination thereof, generated during the sampling iteration 254T. Optionally, in some embodiments, the FSG 266 of a sampling iteration 254 can additionally, or alternatively, include a FS 476 of one or more of the US stages 454 of the sampling iteration 254.

The sampling engine 234 provides the latent representation 256T to the image decoder 218 and provides the FSG 266 of one or more sampling iterations 254 to the mask decoder 216, as described with reference to FIG. 2. For example, the FSG 266T is provided to the mask decoder 216.

Referring to FIG. 5, a diagram 500 is shown of an illustrative aspect of the mask decoder 216, in accordance with some examples of the present disclosure. In some aspects, the mask decoder 216 corresponds to a light-weight version of the image decoder 218 of FIG. 2. For example, the mask decoder 216 includes fewer channels per layer than the image decoder 218.

The mask decoder 216 includes an aggregator 504 coupled to a machine-learning (ML) model 506. The aggregator 504 is configured to generate an aggregated feature set 568 based on aggregating one or more FSG 266 (e.g., the FSG 266T) obtained from the diffusion model 214. The ML model 506 is trained to generate mask data 562 based on the aggregated feature set 568. Optionally, in some embodiments, updating one or more parameters of the mask decoder 216, as described with reference to FIG. 3, includes updating one or more parameters of the ML model 506.

Optionally, in some embodiments, the mask decoder 216 includes one or more scalers 502 coupled to the aggregator 504. For example, the mask decoder 216 includes a scaler 502B, a scaler 502C, a scaler 502D, one or more additional scalers, or a combination thereof. The one or more scalers 502 are configured to scale one or more of the FS 466 to the same (e.g., common) resolution. In embodiments in which the mask decoder 216 does not include the one or more scalers 502, the aggregator 504 uses the unscaled versions of the FS 466 to generate the aggregated feature set 568. Optionally, in some embodiments, the mask decoder 216 includes a US stage 508 coupled to the ML model 506. In embodiments in which the mask decoder 216 does not include the US stage 508, the mask decoder 216 outputs the mask data 562 as the mask data 262. To illustrate, the ML model 506 outputs scaled mask data.

The mask decoder 216 obtains a FSG 266 (e.g., the FSG 266T) from the diffusion model 214 of the sampling engine 234, as described with reference to FIG. 2. The one or more scalers 502 scale one or more feature sets of the FSG 266 to generate one or more FS 566 (e.g., input feature sets) having the same (e.g., common) resolution.

In an example, the common resolution corresponds to the second resolution (e.g., 32 bits by 32 bits) of the FS 466A and the FS 466A is provided as a FS 566A to the aggregator 504. The scaler 502B scales the FS 466B from the third resolution (e.g., 16 bits by 16 bits) to generate a FS 566B having the second resolution. Similarly, the scaler 502C scales the FS 466C from the fourth resolution (e.g., 8 bits by 8 bits) to generate a FS 566C having the second resolution. As another example, the scaler 502D scales the FS 466D from the fifth resolution (e.g., 4 bits by 4 bits) to generate a FS 566D having the second resolution.

The aggregator 504 aggregates one or more FS 566 (e.g., the FS 566A, the FS 566B, the FS 566C, and the FS 566D) to generate the aggregated feature set 568. Optionally, in some embodiments, the aggregator 504 concatenates the one or more FS 566 (e.g., the FS 566A, the FS 566B, the FS 566C, and the FS 566D) to generate the aggregated feature set 568. Optionally, in some embodiments, the aggregator 504 generates the aggregated feature set 568 including feature values that are representative of corresponding feature values of the one or more FS 566 (e.g., the FS 566A, the FS 566B, the FS 566C, and the FS 566D). For example, the aggregated feature set 568 indicates a first value (e.g., mean, median, or mode) of a first feature that is based on a value of the first feature indicated in each of the one or more FS 566 (e.g., the FS 566A, the FS 566B, the FS 566C, and the FS 566D).

The ML model 506 generates mask data 562 based on the aggregated feature set 568. Optionally, in some embodiments, the aggregated feature set 568 has the second resolution (e.g., 32 bits by 32 bits) and the mask data 562 indicates a mask having the second resolution. The US stage 508 upsamples the mask data 562 to generate the mask data 262 representing a mask 168 having the first resolution (e.g., 64 bits by 64 bits).

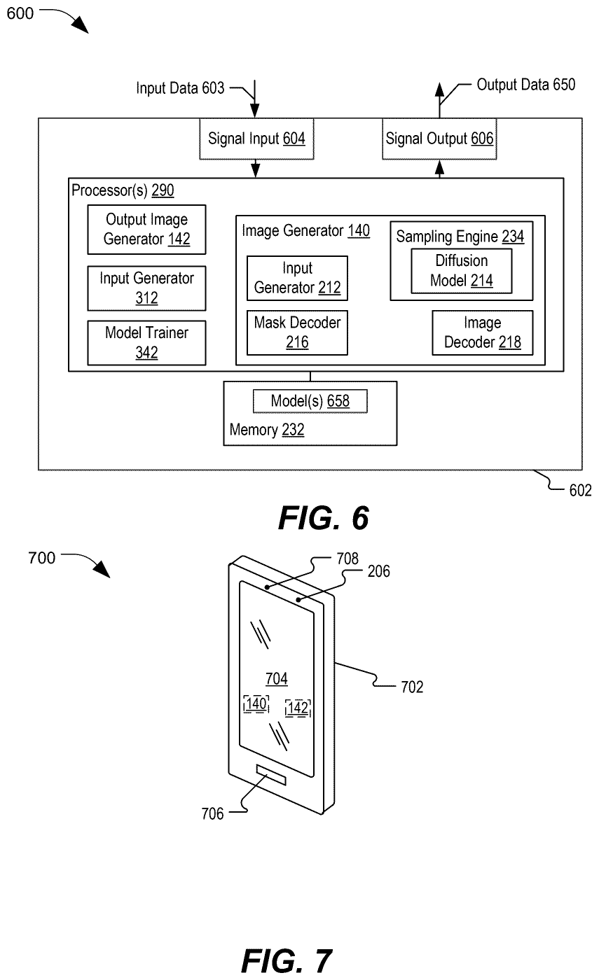

FIG. 6 depicts an implementation 600 of the device 202 as an integrated circuit 602 that includes the one or more processors 290 that include at least the mask decoder 216 of the image generator 140. Optionally, in some embodiments, the one or more processors 290 include one or more of the input generator 212, the diffusion model 214, the sampling engine 234, the image decoder 218, the output image generator 142, the input generator 312, or the model trainer 342.

The one or more processors 290 are coupled to the memory 232. In some embodiments, the memory 232 is included in the integrated circuit 602 as on-chip memory. In some embodiments, the memory 232 is off-chip memory coupled to the integrated circuit 602. The memory 232 is configured to store one or more machine learning models 658. For example, the model(s) 658 include the diffusion model 214 of FIG. 2, the ML model 506 of FIG. 5, or both.

The integrated circuit 602 also includes a signal input 604, such as one or more bus interfaces, to enable input data 603 to be received for processing. The integrated circuit 602 also includes a signal output 606, such as a bus interface, to enable sending of output data 650. In some aspects, the input data 603 includes an input 105, a generated image 158, a background image 160, mask data 262, a latent representation 252, an object type 250, one or more FSG 266, a latent representation 256, or a combination thereof. In some aspects, the output data 650 includes a generated image 158, an output image 164, mask data 262, a latent representation 252, an object type 250, one or more FSG 266, a latent representation 256, or a combination thereof.

The integrated circuit 602 enables implementation of image object mask generation as a component in a system, such as a mobile phone or tablet as depicted in FIG. 7, a headset as depicted in FIG. 8, a mixed reality or augmented reality glasses device, as described with reference to FIG. 9, a voice-controlled speaker system, as described with reference to FIG. 10, a camera device, as described with reference to FIG. 11, or a virtual reality, mixed reality, or augmented reality headset, as described with reference to FIG. 12. In another illustrative example, the integrated circuit 602 is integrated into a vehicle, such as described further with reference to FIG. 13 and FIG. 14.

FIG. 7 depicts an implementation 700 in which the device 202 includes a mobile device 702, such as a phone or tablet, as illustrative, non-limiting examples. The mobile device 702 includes the speaker 206, a camera 708, a microphone 706, and a display screen 704. In some implementations, the mobile device 702 includes the integrated circuit 602 of FIG. 6.

The one or more processors 290 are integrated in the mobile device 702. The one or more processors 290 include at least the mask decoder 216 of the image generator 140. Optionally, in some embodiments, the one or more processors 290 include the input generator 212, the diffusion model 214, the sampling engine 234, the image decoder 218, the output image generator 142, the input generator 312, or the model trainer 342. In an example, the image generator 140 and the output image generator 142 are integrated in the mobile device 702 and are illustrated using dashed lines to indicate internal components that are not generally visible to a user of the mobile device 702.

In a particular example, the image generator 140 and the output image generator 142 operate to detect an input, which is then processed to perform one or more operations at the mobile device 702, such as to launch a graphical user interface or otherwise display other information associated with the input at the display screen 704 (e.g., via an integrated “smart assistant” application). To illustrate, the image generator 140 receives the input 105 indicating user voice activity, the camera 708 generates the background image 160, and the output image generator 142 provides the output image 164 to the display screen 704.

FIG. 8 depicts an implementation 800 in which the device 202 includes a wearable electronic device 802, illustrated as a “smart watch.” The wearable electronic device 802 includes at least the mask decoder 216 of the image generator 140. Optionally, in some embodiments, the wearable electronic device 802 includes one or more of the input generator 212, the diffusion model 214, the sampling engine 234, the image decoder 218, the output image generator 142, the input generator 312, or the model trainer 342. In some implementations, the wearable electronic device 802 includes the integrated circuit 602 of FIG. 6.

In an example, the image generator 140, the output image generator 142, the speaker 206, the microphone 706, and the camera 708 are integrated into the wearable electronic device 802. In a particular example, the image generator 140 operates to detect an input, which is then processed to perform one or more operations at the wearable electronic device 802, such as to launch a graphical user interface or otherwise display other information associated with the input at a display screen 804 of the wearable electronic device 802. To illustrate, the wearable electronic device 802 may include the display screen 804 that is configured to display a notification based on input received by the wearable electronic device 802. To illustrate, the image generator 140 receives the input 105, the camera 708 generates the background image 160, and the output image generator 142 provides the output image 164 to the display screen 704.

In a particular example, the wearable electronic device 802 includes a haptic device that provides a haptic notification (e.g., vibrates) in response to detection of user voice activity. For example, the haptic notification can cause a user to look at the wearable electronic device 802 to see a displayed notification indicating detection of a keyword spoken by the user. The wearable electronic device 802 can thus alert a user with a hearing impairment or a user wearing a headset that the user's voice activity is detected and that the output image 164 is displayed.

FIG. 9 depicts an implementation 900 in which the device 202 includes a portable electronic device that corresponds to augmented reality or mixed reality glasses 902. The glasses 902 include a holographic projection unit 904 configured to project visual data onto a surface of a lens 906 or to reflect the visual data off of a surface of the lens 906 and onto the wearer's retina. In some implementations, the glasses 902 include the integrated circuit 602 of FIG. 6.

The glasses 902 include at least the mask decoder 216 of the image generator 140. Optionally, in some embodiments, the glasses 902 include one or more of the input generator 212, the diffusion model 214, the sampling engine 234, the image decoder 218, the output image generator 142, the input generator 312, or the model trainer 342. In an example, the image generator 140, the output image generator 142, the speaker 206, the microphone 706, the camera 708, or a combination thereof, are integrated into the glasses 902.

The image generator 140 may function to generate the generated image 158 and the mask data 262 based on audio signals received from the microphone 706. The camera 708 may generate the background image 160. In a particular example, the holographic projection unit 904 is configured to display a notification indicating user speech detected in the audio signal. In a particular example, the holographic projection unit 904 is configured to display a notification indicating a detected audio event. For example, the notification can be superimposed on the user's field of view at a particular position that coincides with the location of the source of the sound associated with the audio event. To illustrate, the sound may be perceived by the user as emanating from the direction of the notification. In an illustrative implementation, the holographic projection unit 904 is configured to display the output image 164 generated by the output image generator 142 based on the generated image 158, the mask data 262, and the background image 160.

FIG. 10 is an implementation 1000 in which the device 202 includes a wireless speaker and voice activated device 1002. The wireless speaker and voice activated device 1002 can have wireless network connectivity and is configured to execute an assistant operation. In some implementations, the wireless speaker and voice activated device 1002 includes the integrated circuit 602 of FIG. 6.

In an example, the one or more processors 290, the microphone 706, the camera 708, the speaker 206, or a combination thereof, are included in the wireless speaker and voice activated device 1002. The one or more processors 290 includes at least the mask decoder 216 of the image generator 140. Optionally, in some embodiments, the one or more processors 290 include one or more of the input generator 212, the diffusion model 214, the sampling engine 234, the image decoder 218, the output image generator 142, the input generator 312, or the model trainer 342.

During operation, in response to receiving an input, the wireless speaker and voice activated device 1002 can execute assistant operations, such as via execution of a voice activation system (e.g., an integrated assistant application). The assistant operations can include adjusting a temperature, playing music, turning on lights, displaying a generated image, etc. For example, the assistant operations are performed responsive to receiving a command after a keyword or key phrase (e.g., “hello assistant”) and can include displaying the output image 164 at a display screen 1004 of the wireless speaker and voice activated device 1002.

FIG. 11 depicts an implementation 1100 in which the device 202 includes a portable electronic device that corresponds to a camera device 1102. The camera device 1102 includes at least the mask decoder 216 of the image generator 140. Optionally, in some embodiments, the camera device 1102 includes one or more of the input generator 212, the diffusion model 214, the sampling engine 234, the image decoder 218, the output image generator 142, the input generator 312, or the model trainer 342. In some implementations, the camera device 1102 includes the integrated circuit 602 of FIG. 6.

In an example, the image generator 140, the output image generator 142, the speaker 206, the microphone 706, or a combination thereof, are included in the camera device 1102. During operation, in response to receiving an input, the camera device 1102 can execute operations, such as to adjust image or video capture settings, image or video playback settings, or image or video capture instructions, as illustrative examples. In an example, the camera device 1102 captures the background image 160, the image generator 140 generates the generated image 158 and the mask data 262, and the output image generator 142 generates the output image 164.

FIG. 12 depicts an implementation 1200 in which the device 202 includes a portable electronic device that corresponds to a virtual reality, mixed reality, or augmented reality headset 1202. The headset 1202 includes at least the mask decoder 216 of the image generator 140. Optionally, in some embodiments, the headset 1202 includes one or more of the input generator 212, the diffusion model 214, the sampling engine 234, the image decoder 218, the output image generator 142, the input generator 312, or the model trainer 342. In some implementations, the headset 1202 includes the integrated circuit 602 of FIG. 6.

In an example, the image generator 140, the output image generator 142, the speaker 206, the microphone 706, the camera 708, or a combination thereof, are integrated into the headset 1202. A visual interface device is positioned in front of the user's eyes to enable display of augmented reality, mixed reality, or virtual reality images or scenes to the user while the headset 1202 is worn. In a particular example, the visual interface device is configured to display a notification based on a received input. To illustrate, the visual interface device is configured to display the segmented image 172 or the output image 164 that are generated based on an input 105 received via the microphone 706.

FIG. 13 depicts an implementation 1300 in which the device 202 corresponds to, or is integrated within, a vehicle 1302, illustrated as a manned or unmanned aerial device (e.g., a package delivery drone). The vehicle 1302 includes at least the mask decoder 216 of the image generator 140. Optionally, in some embodiments, the vehicle 1302 includes one or more of the input generator 212, the sampling engine 234, the diffusion model 214, the image decoder 218, the output image generator 142, the input generator 312, or the model trainer 342. In some implementations, the vehicle 1302 includes the integrated circuit 602 of FIG. 6.

In an example, the image generator 140, the output image generator 142, the speaker 206, the microphone 706, the camera 708, or a combination thereof, are integrated into the vehicle 1302. User voice activity detection can be performed based on audio signals received from the microphone 706 of the vehicle 1302, such as a request for installation instructions from a recipient of a package delivered by the vehicle 1302. In an example, the image generator 140 generates the generated image 158 and the mask data 262, the camera 708 captures a background image 160, and the output image generator 142 generates the output image 164. To illustrate, the segmented image 172 includes a representation of an object delivered by the vehicle 1302 and the background image 160 includes a representation of a location at which the object is to be installed. The output image 164 is displayed at a display screen of the vehicle 1302, a user device, or both.

FIG. 14 depicts another implementation 1400 in which the device 202 corresponds to, or is integrated within, a vehicle 1402, illustrated as a car. The vehicle 1402 includes at least the mask decoder 216 of the image generator 140. Optionally, in some embodiments, the vehicle 1402 includes one or more of the input generator 212, the diffusion model 214, the sampling engine 234, the image decoder 218, the output image generator 142, the input generator 312, or the model trainer 342. In some implementations, the vehicle 1402 includes the integrated circuit 602 of FIG. 6.

In an example, the vehicle 1402 includes the one or more processors 290 including the image generator 140 and the output image generator 142. The vehicle 1402 also includes the speaker 206, the microphone 706, and the camera 708. User voice activity detection can be performed based on audio signals received from the microphone 706 of the vehicle 1402. In some implementations, user voice activity detection can be performed based on an audio signal received from interior microphones (e.g., the microphone 706), such as for a voice command from an authorized passenger. For example, the user voice activity detection can be used to detect a voice command from an operator of the vehicle 1402 (e.g., to set a destination for a self-driving vehicle) and to disregard the voice of another passenger (e.g., other passengers discussing another location). In some implementations, user voice activity detection can be performed based on an audio signal received from external microphones (e.g., the microphone 706), such as an authorized user of the vehicle.

In a particular implementation, in response to receiving a verbal command identified as user speech received via the microphone 706, a voice activation system initiates one or more operations of the vehicle 1402 based on one or more keywords (e.g., “unlock,” “start engine,” “play music,” “display weather forecast,” or another voice command) detected in the input 105, such as by providing feedback or information via a display 1420 or one or more speakers 206. In an example, the output image 164, generated by the output image generator 142, is displayed at the display 1420.

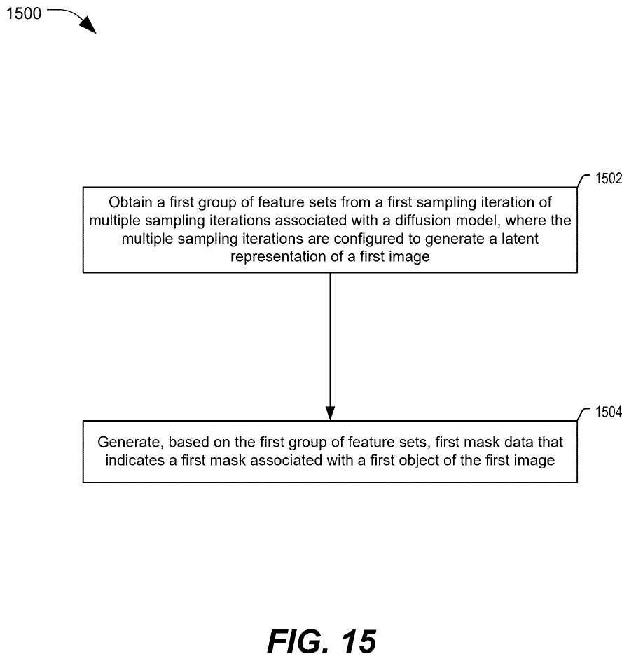

Referring to FIG. 15, a particular implementation of a method 1500 of image object mask generation is shown. In a particular aspect, one or more operations of the method 1500 are performed by at least one of the mask decoder 216, the diffusion model 214, the image generator 140 of FIG. 1, the sampling engine 234, the one or more processors 290, the device 202, the system 200 of FIG. 2, the integrated circuit 602 of FIG. 6, or a combination thereof.

The method 1500 includes, at 1502, obtaining a first group of feature sets from a first sampling iteration of multiple sampling iterations associated with a diffusion model, where the multiple sampling iterations are configured to generate a latent representation of a first image. For example, as described with reference to FIGS. 2 and 4, the mask decoder 216 obtains one or more FSG 266 from one or more sampling iterations 254 of the diffusion model 214. To illustrate, the mask decoder 216 obtains the FSG 266T from the sampling iteration 254T. The sampling iterations 254 are configured to generate the latent representation 256T of the generated image 158.

The method 1500 also includes, at 1504, generating, based on the first group of feature sets, first mask data that indicates a first mask associated with a first object of the first image. For example, as described with reference to FIGS. 2 and 5, the mask decoder 216, based on the one or more FSG 266 (e.g., the FSG 266T), generates the mask data 262 that indicates the mask 168 associated with an object of the generated image 158.

The method 1500 improves image object segmentation. For example, using the mask 168 for object segmentation reduces portions of the generated image 158, other than at least a portion of the object representation 170, that are included in the segmented image 172, and the segmented image 172 can be used to generate the output image 164 including at least the portion of the object representation 170 (e.g., a vehicle) with fewer additional artifacts (e.g., portion of a road or trees) from the generated image 158.

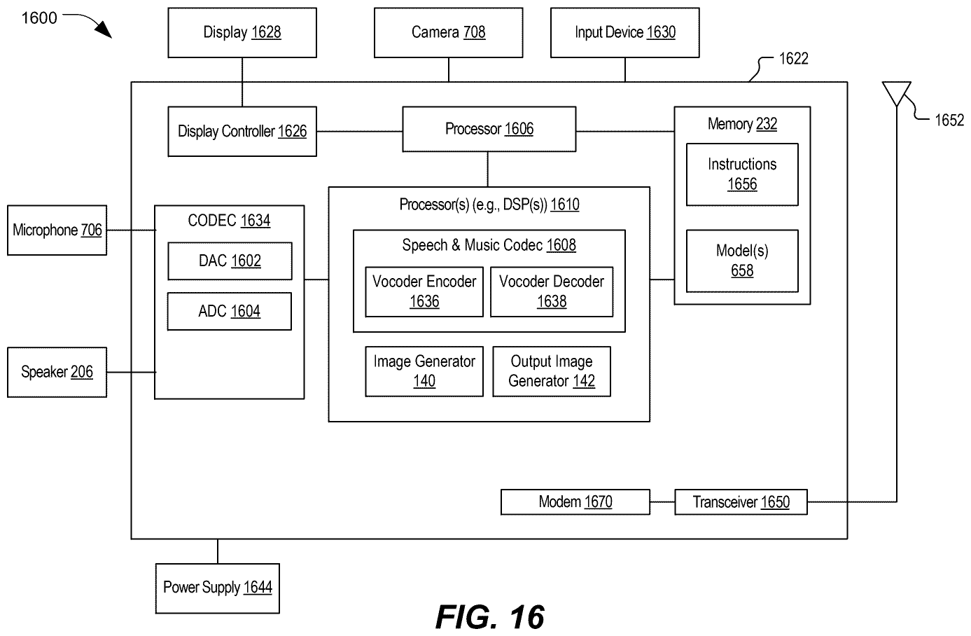

The method 1500 of FIG. 15 may be implemented by a field-programmable gate array (FPGA) device, an application-specific integrated circuit (ASIC), a processing unit such as a central processing unit (CPU), a digital signal processor (DSP), a controller, another hardware device, firmware device, or any combination thereof. As an example, the method 1500 of FIG. 15 may be performed by a processor that executes instructions, such as described with reference to FIG. 16.

Referring to FIG. 16, a block diagram of a particular illustrative implementation of a device is depicted and generally designated 1600. In various implementations, the device 1600 may have more or fewer components than illustrated in FIG. 16. In an illustrative implementation, the device 1600 may correspond to the device 202. In an illustrative implementation, the device 1600 may perform one or more operations described with reference to FIGS. 1-15.

In a particular implementation, the device 1600 includes a processor 1606 (e.g., a CPU). The device 1600 may include one or more additional processors 1610 (e.g., one or more DSPs). In a particular aspect, the one or more processors 290 of FIG. 2 corresponds to the processor 1606, the processors 1610, or a combination thereof. The processors 1610 may include a speech and music coder-decoder (CODEC) 1608 that includes a voice coder (“vocoder”) encoder 1636, a vocoder decoder 1638, or both. The processors 1610 may include the image generator 140, the output image generator 142, or both. In some implementations, the device 1600 includes the integrated circuit 602 of FIG. 6.

In a particular aspect, the processors 1610 include at least the mask decoder 216 of the image generator 140. Optionally, in some embodiments, the processors 1610 include one or more of the input generator 212, the diffusion model 214, the sampling engine 234, the image decoder 218, the output image generator 142, the input generator 312, or the model trainer 342.

The device 1600 may include the memory 232 and a CODEC 1634. The memory 232 may include instructions 1656, that are executable by the one or more additional processors 1610 (or the processor 1606) to implement the functionality described with reference to the mask decoder 216. Optionally, in some embodiments, the instructions 1656 are executable to implement the functionality described with reference to the input generator 212, the diffusion model 214, the sampling engine 234, the image decoder 218, the output image generator 142, the input generator 312, or the model trainer 342. The memory 232 may store the one or more models 658. The device 1600 may include a modem 1670 coupled, via a transceiver 1650, to an antenna 1652. In a particular aspect, the modem 1670 is configured to receive or transmit data used or generated by the mask decoder 216, the input generator 212, the diffusion model 214, the image decoder 218, the output image generator 142, the input generator 312, or the model trainer 342. As an example, the modem 1670 is configured to transmit the latent representation 256T, the mask data 262, the generated image 158, or a combination there of, to a second device. In some aspects, the output image generator 142 is integrated in the second device.

The device 1600 may include a display 1628 coupled to a display controller 1626. The speaker 206 and the microphone 706 may be coupled to the CODEC 1634. The CODEC 1634 may include a digital-to-analog converter (DAC) 1602, an analog-to-digital converter (ADC) 1604, or both. In a particular implementation, the CODEC 1634 may receive analog signals from the microphone 706, convert the analog signals to digital signals using the analog-to-digital converter 1604, and provide the digital signals to the speech and music codec 1608. The speech and music codec 1608 may process the digital signals, and the digital signals may further be processed by the image generator 140. In a particular implementation, the speech and music codec 1608 may provide digital signals to the CODEC 1634. For example, the output image generator 142 may provide digital signals to the CODEC 1634 corresponding to audio associated with an object represented in a segmented image 172. The CODEC 1634 may convert the digital signals to analog signals using the digital-to-analog converter 1602 and may provide the analog signals to the speaker 206.

In a particular implementation, the device 1600 may be included in a system-in-package or system-on-chip device 1622. In a particular implementation, the memory 232, the processor 1606, the processors 1610, the display controller 1626, the CODEC 1634, and the modem 1670 are included in the system-in-package or system-on-chip device 1622. In a particular implementation, an input device 1630 and a power supply 1644 are coupled to the system-in-package or the system-on-chip device 1622. Moreover, in a particular implementation, as illustrated in FIG. 16, the display 1628, the input device 1630, the speaker 206, the microphone 706, the camera 708, the antenna 1652, and the power supply 1644 are external to the system-in-package or the system-on-chip device 1622. In a particular implementation, each of the display 1628, the input device 1630, the speaker 206, the microphone 706, the camera 708, the antenna 1652, and the power supply 1644 may be coupled to a component of the system-in-package or the system-on-chip device 1622, such as an interface or a controller. In a particular aspect, the input device 204 of FIG. 2 includes the microphone 706, the camera 708, the input device 1630, or a combination thereof.

The device 1600 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described implementations, an apparatus includes means for obtaining a first group of feature sets from a first sampling iteration of multiple sampling iterations associated with a diffusion model, where the multiple sampling iterations are configured to generate a latent representation of a first image. For example, the means for obtaining can correspond to the diffusion model 214, the mask decoder 216, the image generator 140, the device 202, the system 200, the scalers 502, the aggregator 504, the signal input 604, the integrated circuit 602, the processor 1606, the processors 1610, the modem 1670, the transceiver 1650, the antenna 1652, the device 1600, one or more other circuits or components configured to obtain a group of feature sets from a sampling iteration of a diffusion model, or any combination thereof.

The apparatus also includes means for generating, based on the first group of feature sets, first mask data that indicates a first mask associated with a first object of the first image. For example, the means for generating can correspond to the mask decoder 216, the image generator 140, the device 202, the system 200, the scalers 502, the aggregator 504, the ML model 506, the US stage 508, the integrated circuit 602, the processor 1606, the processors 1610, the device 1600, one or more other circuits or components configured to generate the mask data, or any combination thereof.

In some implementations, a non-transitory computer-readable medium (e.g., a computer-readable storage device, such as the memory 232) includes instructions (e.g., the instructions 1656) that, when executed by one or more processors (e.g., the one or more processors 1610 or the processor 1606), cause the one or more processors to obtain a first group of feature sets (e.g., the FSG 266T) from a first sampling iteration (e.g., the sampling iteration 254T) of multiple sampling iterations (e.g., the sampling iterations 254) associated with a diffusion model (e.g., the diffusion model 214), where the multiple sampling iterations are configured to generate a latent representation (e.g., the latent representation 256T) of a first image (e.g., the generated image 158). The instructions, when executed by the one or more processors, further cause the one or more processors to generate, based on the first group of feature sets, first mask data (e.g., the mask data 262) that indicates a first mask (e.g., the mask 168) associated with a first object of the first image.

Particular aspects of the disclosure are described below in sets of interrelated Examples:

According to Example 1, a device includes a memory configured to store image data. The device also includes one or more processors coupled to the memory and configured to obtain a first group of feature sets from a first sampling iteration of multiple sampling iterations associated with a diffusion model, wherein the multiple sampling iterations are configured to generate a latent representation of a first image.

The one or more processors are also configured to generate, based on the first group of feature sets, first mask data that indicates a first mask associated with a first object of the first image.

Example 2 includes the device of Example 1, wherein the first sampling iteration corresponds to a final sampling iteration of the multiple sampling iterations.

Example 3 includes the device of Example 1 or Example 2, wherein a first feature set of the first group of feature sets has a first resolution, and wherein a second feature set of the first group of feature sets has a second resolution that is distinct from the first resolution.

Example 4 includes the device of any of Examples 1 to 3, wherein: the diffusion model includes multiple downsampling stages; and each feature set of the first group of feature sets corresponds to a respective downsampling stage of the multiple downsampling stages of the diffusion model.

Example 5 includes the device of any of Examples 1 to 4, wherein: the one or more processors are configured to scale one or more feature sets of the first group of feature sets to generate input feature sets, each of the input feature sets having a same resolution; and the first mask data is based on the input feature sets.

Example 6 includes the device of Example 5, wherein: the one or more processors are configured to aggregate the input feature sets to generate an aggregated feature set; and the first mask data is based on the aggregated feature set.

Example 7 includes the device of Example 6, wherein the one or more processors are configured to concatenate the input feature sets to generate the aggregated feature set.

Example 8 includes the device of any of Examples 1 to 7, wherein: the one or more processors are configured to obtain a second group of feature sets from a second sampling iteration of the multiple sampling iterations; and the first mask data is further based on the second group of feature sets.

Example 9 includes the device of any of Examples 1 to 8, wherein the one or more processors are configured to obtain a background image; and generate, based on the first image and the first mask data, an output image that includes a representation of the first object and at least a portion of the background image.

Example 10 includes the device of Example 9, and further includes a camera coupled to the one or more processors, wherein the camera is configured to generate the background image.

Example 11 includes the device of Example 9 or Example 10, and further includes a display device coupled to the one or more processors, wherein the display device is configured to display the output image.

Example 12 includes the device of Example 11, and further includes a speaker coupled to the one or more processors, wherein the speaker is configured to, concurrently with the output image being displayed at the display device, output audio associated with the first object.

Example 13 includes the device of any of Examples 1 to 12, wherein the one or more processors are configured to generate, based on a group of feature sets from at least one sampling iteration of second sampling iterations associated with the diffusion model, second mask data that indicates a second mask associated with a second object of a second image, wherein the second sampling iterations are configured to generate a latent representation of the second image.

Example 14 includes the device of Example 13, wherein: the one or more processors are configured to generate an output image including a representation of the first object, a representation of the second object, and at least a portion of a background image; the representation of the first object is based on the first image and the first mask data; and the representation of the second object is based on the second image and the second mask data.

Example 15 includes the device of any of Examples 1 to 14, and further includes: an input device coupled to the one or more processors, wherein: the one or more processors are configured to receive, from the input device, an input that indicates an object type of the first object; and the diffusion model is configured to generate, based on the object type of the first object, the latent representation of the first image including the first object.

Example 16 includes the device of any of Examples 1 to 15, wherein the one or more processors are configured to use the diffusion model to process an input latent representation of noise data to generate the latent representation of the first image, the noise data sampled from a noise distribution.

Example 17 includes the device of any of Examples 1 to 16, wherein the one or more processors are configured to generate an input latent representation based on an encoded image and noise data; use the diffusion model to process the input latent representation to generate the latent representation of the first image; use a mask decoder to generate the first mask data based on the first group of feature sets; and update one or more parameters of the mask decoder based on a comparison of the first mask data and training mask data, the training mask data indicating a mask associated with a representation of the first object in the encoded image.

Example 18 includes the device of any of Examples 1 to 17, and further includes a modem coupled to the one or more processors, the modem configured to transmit the latent representation of the first image and the first mask data.

According to Example 18, a method of operation of a device, the method includes obtaining a first group of feature sets from a first sampling iteration of multiple sampling iterations associated with a diffusion model, wherein the multiple sampling iterations are configured to generate a latent representation of a first image; and generating, based on the first group of feature sets, first mask data that indicates a first mask associated with a first object of the first image.

Example 19 includes the method of Example 18, the method further comprising using the diffusion model to process an input latent representation of noise data to generate the latent representation of the first image, the noise data sampled from a noise distribution.

Example 20 includes the method of Example 18 or Example 19, wherein the first sampling iteration corresponds to a final sampling iteration of the multiple sampling iterations.

Example 21 includes the method of any of Example 18 to 20, wherein a first feature set of the first group of feature sets has a first resolution, and wherein a second feature set of the first group of feature sets has a second resolution that is distinct from the first resolution.

Example 22 includes the method of any of Examples 18 to 21, wherein: the diffusion model includes multiple downsampling stages; and each feature set of the first group of feature sets corresponds to a respective downsampling stage of the multiple downsampling stages of the diffusion model.

Example 23 includes the method of any of Examples 18 to 22, the method further comprising scaling one or more feature sets of the first group of feature sets to generate input feature sets, each of the input feature sets having a same resolution, wherein the first mask data is based on the input feature sets.

Example 24 includes the method of Example 23, the method further comprising aggregating the input feature sets to generate an aggregated feature set, wherein the first mask data is based on the aggregated feature set.

Example 25 includes the method of Example 24, the method further comprising concatenating the input feature sets to generate the aggregated feature set.

Example 26 includes the method of any of Examples 18 to 25, the method further comprising obtaining a second group of feature sets from a second sampling iteration of the multiple sampling iterations, wherein the first mask data is further based on the second group of feature sets.

Example 27 includes the method of any of Examples 18 to 26, the method further comprising: obtaining a background image; and generating, based on the first image and the first mask data, an output image that includes a representation of the first object and at least a portion of the background image.

Example 28 includes the method of Example 27, the method further comprising generating the background image at a camera.

Example 29 includes the method of Example 27 or Example 28, the method further comprising displaying the output image at a display device.

Example 30 includes the method of Example 29, the method further comprising outputting, via a speaker, audio associated with the first object concurrently with the output image being displayed at the display device.

Example 31 includes the method of any of Examples 18 to 30, the method further comprising generating, based on a group of feature sets from at least one sampling iteration of second sampling iterations associated with the diffusion model, second mask data that indicates a second mask associated with a second object of a second image, wherein the second sampling iterations are configured to generate a latent representation of the second image.

Example 32 includes the method of Example 31, the method further comprising generating an output image including a representation of the first object, a representation of the second object, and at least a portion of a background image, wherein the representation of the first object is based on the first image and the first mask data, and wherein the representation of the second object is based on the second image and the second mask data.

Example 33 includes the method of any of Examples 18 to 32, the method further comprising receiving, from an input device, an input that indicates an object type of the first object, wherein the diffusion model is configured to generate, based on the object type of the first object, the latent representation of the first image including the first object.

Example 34 includes the method of any of Examples 18 to 33, the method further comprising: generating an input latent representation based on an encoded image and noise data; using the diffusion model to process the input latent representation to generate the latent representation of the first image; using a mask decoder to generate the first mask data based on the first group of feature sets; and updating one or more parameters of the mask decoder based on a comparison of the first mask data and training mask data, the training mask data indicating a mask associated with a representation of the first object in the encoded image.

Example 35 includes the method of any of Examples 18 to 34, the method further comprising transmitting, via a modem, the latent representation of the first image and the first mask data.

According to Example 36, a non-transitory computer-readable medium stores instructions that, when executed by one or more processors, cause the one or more processors to obtain a first group of feature sets from a first sampling iteration of multiple sampling iterations associated with a diffusion model, wherein the multiple sampling iterations are configured to generate a latent representation of a first image. The instructions, when executed by the one or more processors, also cause the one or more processors to generate, based on the first group of feature sets, first mask data that indicates a first mask associated with a first object of the first image.

According to Example 37, an apparatus includes means for obtaining a first group of feature sets from a first sampling iteration of multiple sampling iterations associated with a diffusion model, where the multiple sampling iterations are configured to generate a latent representation of a first image. The apparatus also includes means for generating, based on the first group of feature sets, first mask data that indicates a first mask associated with a first object of the first image.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store image data; and
one or more processors coupled to the memory and configured to:
obtain a first group of feature sets from a first sampling iteration of multiple sampling iterations associated with a diffusion model, wherein the multiple sampling iterations are configured to generate a latent representation of a first image; and
generate, based on the first group of feature sets, first mask data that indicates a first mask associated with a first object of the first image.

2. The device of claim 1, wherein the first sampling iteration corresponds to a final sampling iteration of the multiple sampling iterations.

3. The device of claim 1, wherein a first feature set of the first group of feature sets has a first resolution, and wherein a second feature set of the first group of feature sets has a second resolution that is distinct from the first resolution.

4. The device of claim 1, wherein:
the diffusion model includes multiple downsampling stages; and
each feature set of the first group of feature sets corresponds to a respective downsampling stage of the multiple downsampling stages of the diffusion model.

5. The device of claim 1, wherein:
the one or more processors are configured to scale one or more feature sets of the first group of feature sets to generate input feature sets, each of the input feature sets having a same resolution; and
the first mask data is based on the input feature sets.

6. The device of claim 5, wherein:
the one or more processors are configured to aggregate the input feature sets to generate an aggregated feature set; and
the first mask data is based on the aggregated feature set.

7. The device of claim 6, wherein the one or more processors are configured to concatenate the input feature sets to generate the aggregated feature set.

8. The device of claim 1, wherein:
the one or more processors are configured to obtain a second group of feature sets from a second sampling iteration of the multiple sampling iterations; and
the first mask data is further based on the second group of feature sets.

9. The device of claim 1, wherein the one or more processors are configured to:
obtain a background image; and
generate, based on the first image and the first mask data, an output image that includes a representation of the first object and at least a portion of the background image.

10. The device of claim 9, further comprising a camera coupled to the one or more processors, wherein the camera is configured to generate the background image.

11. The device of claim 9, further comprising a display device coupled to the one or more processors, wherein the display device is configured to display the output image.

12. The device of claim 11, further comprising a speaker coupled to the one or more processors, wherein the speaker is configured to, concurrently with the output image being displayed at the display device, output audio associated with the first object.

13. The device of claim 1, wherein the one or more processors are configured to generate, based on a group of feature sets from at least one sampling iteration of second sampling iterations associated with the diffusion model, second mask data that indicates a second mask associated with a second object of a second image, wherein the second sampling iterations are configured to generate a latent representation of the second image.

14. The device of claim 13, wherein:
the one or more processors are configured to generate an output image including a representation of the first object, a representation of the second object, and at least a portion of a background image;
the representation of the first object is based on the first image and the first mask data; and
the representation of the second object is based on the second image and the second mask data.

15. The device of claim 1, further comprising:
an input device coupled to the one or more processors, wherein:
the one or more processors are configured to receive, from the input device, an input that indicates an object type of the first object; and
the diffusion model is configured to generate, based on the object type of the first object, the latent representation of the first image including the first object.

16. The device of claim 1, wherein the one or more processors are configured to:
generate an input latent representation based on an encoded image and noise data;
use the diffusion model to process the input latent representation to generate the latent representation of the first image;
use a mask decoder to generate the first mask data based on the first group of feature sets; and
update one or more parameters of the mask decoder based on a comparison of the first mask data and training mask data, the training mask data indicating a mask associated with a representation of the first object in the encoded image.

17. The device of claim 1, further comprising a modem coupled to the one or more processors, the modem configured to transmit the latent representation of the first image and the first mask data.

18. A method of operation of a device, the method comprising:
obtaining a first group of feature sets from a first sampling iteration of multiple sampling iterations associated with a diffusion model, wherein the multiple sampling iterations are configured to generate a latent representation of a first image; and
generating, based on the first group of feature sets, first mask data that indicates a first mask associated with a first object of the first image.

19. The method of claim 18, further comprising using the diffusion model to process an input latent representation of noise data to generate the latent representation of the first image, the noise data sampled from a noise distribution.

20. A non-transitory computer-readable medium storing instructions that, when executed by one or more processors, cause the one or more processors to:
obtain a first group of feature sets from a first sampling iteration of multiple sampling iterations associated with a diffusion model, wherein the multiple sampling iterations are configured to generate a latent representation of a first image; and
generate, based on the first group of feature sets, first mask data that indicates a first mask associated with a first object of the first image.
